(19) United States
(12) Patent Application Publication
(10) Pub. No.: US 2021/0390221 A1
(43) Pub. Date: Dec. 16, 2021

(54) RULE-BASED DESIGN SYSTEM

(71) Applicant: Britton Langdon, Cedar Rapids, IA (US)

(72) Inventor: Britton Langdon, Cedar Rapids, IA (US)

(21) Appl. No.: 16/900,266

(22) Filed: Jun. 12, 2020

(51) Int. Cl. G06F 30/13; G06F 30/27

(52) U.S. Cl. CPC G06F 30/13; G06F 2111/04; G06F 30/27

(57) ABSTRACT

A rule-based design system is disclosed, comprising a design database to store a plurality of design information comprised of a plurality of components. A rules database stores a plurality of rules input by a user and which are associated to one or more of the plurality of components. A rules management system applies the plurality of rules to at least one of the plurality of components and modifies the at least one of the plurality of components based on the plurality of rules.

### TECHNICAL FIELD

The embodiments generally relate to computer implemented systems for structure design systems and, more particularly, relate to systems for analyzing and modifying computer-generated designs based on one or more rule parameters.

### BACKGROUND

Building design refers to the broadly based architectural, engineering, and technical applications for the design of buildings or other constructions. All building projects require a building designer, draftsperson, interior designer, contractor, and the like in order to plan the various components of the construction. Complex projects require the expertise of various specialists in a variety of disciplines including electrical professionals, plumbing professionals, and the like in order to create a functional structure.

During the design phase of a structure, professionals consider and analyze the logistics of delivering raw materials or partially constructed materials to the construction site. The professionals often attempt to optimize resources and the delivery thereof in order to lower construction costs by efficiently delivering materials to the site.

Throughout the construction process, various constraints may present themselves. For example, during the construction of a multi-level building, the ability to deliver raw materials may be constrained by the use of an elevator to raise the raw materials to a higher floor, thus requiring the raw materials to be cut to a smaller size for transportation through the elevator. These constraints may change throughout the construction process. In another example, a crane may be needed to lift a component to a higher floor. In some cases, the component may exceed the operational limit of the crane forcing the modification of the building design, or modification of the raw materials before they are delivered to the construction site. In the current arts, designers and professionals must consider these constraints and manually input changes to the design based on these constraints.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a rule-based design system, comprising a design database to store a plurality of design information comprised of a plurality of components. A rules database stores a plurality of rules input by a user and which are associated to one or more of the plurality of components. A rules management system applies the plurality of rules to at least one of the plurality of components and modifies the at least one of the plurality of components based on the plurality of rules.

The rule-based design system may be utilized during the design, planning, and construction of a building or other construction project. The system may also be utilized by various professionals associated with the various forms of construction. The system allows a user to select a third-party system, which will run the rule-based design system. The user may then define the variable or rules by which the algorithm of the rule-based design system will run. The rules will dictate the algorithm's order and preferences for creating assemblies (i.e., the spools) of various components of the design. The system provides a means for inclusion or exclusion within the rules to allow the user to manually forgo rules if necessary. Once the rules, inclusions, and exclusions are determined by the user, the rule-based design system will operate the algorithm to generate modifications to the assemblies within the design. Modifications will be differentiated on the user interface using a color change or other indicator to provide a readily identifiable modification to the assembly and design. Modifications may be stored in a database accessible by a machine learning and artificial intelligence engine to learn user preferences and anticipate modifications in future designs.

In one aspect, the plurality of rules are transmitted to an analysis engine to analyze the rules and apply the rules.

In one aspect, the analysis system comprises an artificial intelligence engine to anticipate the plurality of rules provided by the user.

In one aspect, a user interface provides a means for inputting the plurality of rules.

In one aspect, the user interface comprises a cases and notifications interface to allow the user to select a solution to a breach of at least one of the plurality of rules.

In one aspect, a rule generation module is in operable communication with the user interface to permit the generation of the plurality of rules.

In one aspect, a component generation module generates a component conforming to the plurality of rules.

In one aspect, a design generation module generates a design comprising the conforming component generated by the component generation module.

In one aspect, a user permissions module provides a means for submitting user permissions to access the rule-based design system.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the rule-based design system, according to some embodiments;

FIG. 3 illustrates a block diagram of the databases and analysis engine, according to some embodiments; and

FIG. 4 illustrates a block diagram of the analysis engine, according to some embodiments;

FIG. 5 illustrates a screenshot of the user interface, according to some embodiments;

FIG. 6 illustrates a block diagram of the server engine and modules, according to some embodiments;

FIG. 7 illustrates a block diagram of the server engine and modules, according to some embodiments;

FIG. 8 illustrates a block diagram of the integrated third-party systems, according to some embodiments;

FIG. 9 illustrates a block diagram of the fabrication management engine, according to some embodiments;

FIG. 10 illustrates a flowchart for a method of using the rule-based design system, according to some embodiments; and

FIG. 11 illustrates a flowchart of the rules and modifications process, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “user” may relate to any person interacting with the system including design professionals, draftpersons, architects, electricians, plumbers, and other professionals involved with the planning, design, and construction of a building or other construction project.

In general, the embodiments provided herein relate to a rule-based design system which may be utilized during the design, planning, and construction of a building or other construction project. One skilled in the arts will readily understand that while the example of a building structure is utilized herein, the embodiments may be implemented for various forms of construction including infrastructure construction, industrial construction, special-purpose projects, and the like. The system may also be utilized by various professionals associated with the various forms of construction. The system allows a user select a third-party system, which will run the rule-based design system. The user may then define the variables or rules by which the algorithm of the rule-based design system will run. The rules will dictate the algorithm's order and preferences for creating assemblies (i.e., the spools) of various components of the design. The rules may be industry-specific and based on business logic that one skilled in the arts of the particular industry will readily understand. Further, the system will allow for inclusion or exclusion within the rules to allow the user to manually forgo rules if necessary. Once the rules, inclusions, and exclusions are determined by the user, the rule-based design system will operate the algorithm to generate modifications to the assemblies within the design. Modifications will be differentiated on the user interface using a color change or other indicator to provide a readily identifiable modification to the assembly and design. Modifications may be stored in a database accessible by a machine learning and artificial intelligence engine to learn user preferences and anticipate modifications in future designs.

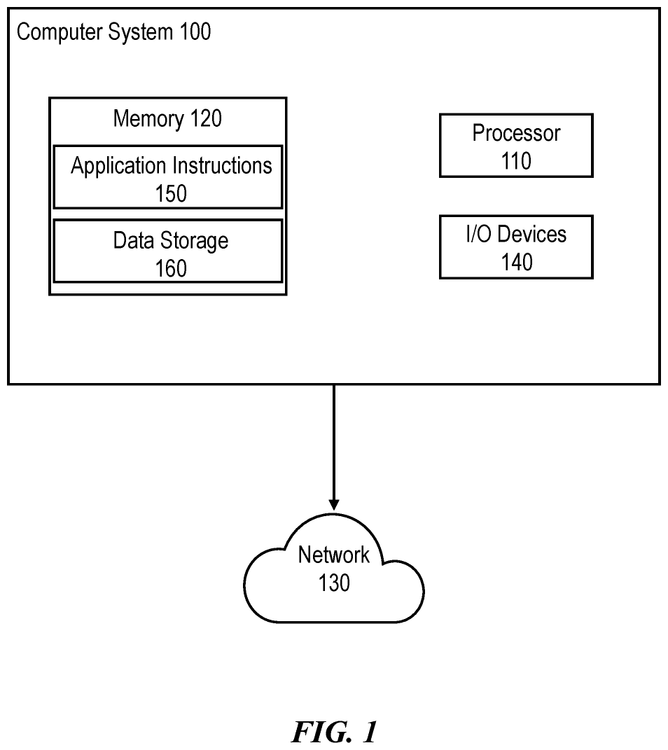

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The memory 120 may operate to store user preferences, rules, limitations, and other user characteristics to provide the stored information to a machine learning and artificial intelligence engine. This may allow for the system to anticipate future design rules provided by the user.

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

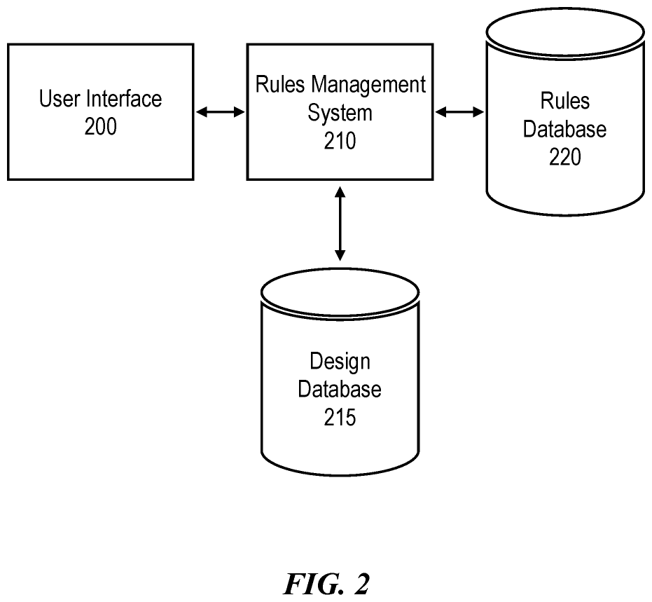

FIG. 2 illustrates a block diagram of the rule-based design system comprising a user interface 200 configured to be operated on a computing device. The rules management system 210 allows the user to manage and implement a plurality of rules for various components of the system during the construction, design, and planning processes. A rules database 220 is in operable communication with the rules management system 210 and stores a plurality of rules for various components of the construction process. The rules database 220 may receive new rules input by a user. A design database 215 stores a plurality of designs corresponding to a construction project, user, organization, and the like. The design database 215 may communicate with the rules management system 210 to determine a subset of rules within the rules database 220 which are applied to each design.

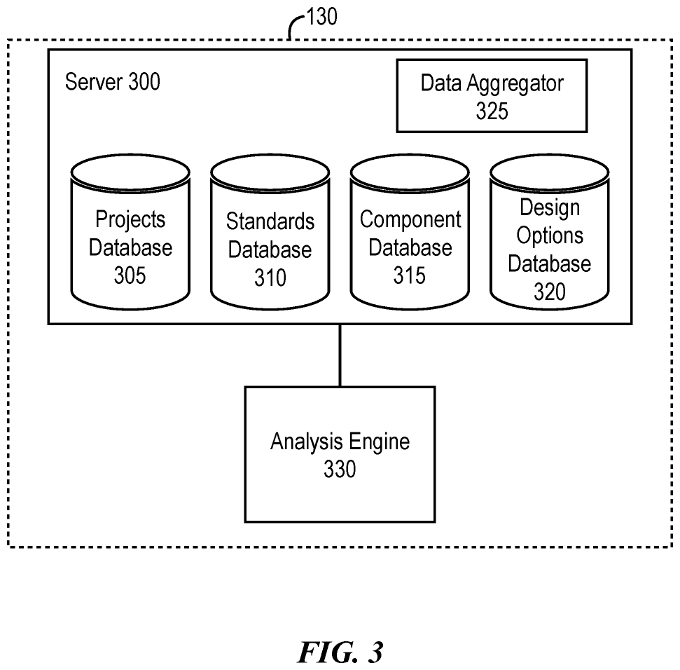

FIG. 3 illustrates a block diagram of the databases in communication with an analysis engine 330 via the network 130. A server 300 is in communication with and is operable to transmit information to and from a projects database 305, a standards database 310, a component database 315, and a design option database 320. A data aggregator 325 aggregates data from each database depending on the particular project. The projects database 305 stores project information for each project, which may include various information commonly associated with a construction project (e.g., contractor information, building information, specifications, and the like). The standards database 310 stores information such as regulatory standards, building codes, best practices, and the like which may alter a component and is provided to the algorithm to modify the component based on one or more standards. A component database 315 stores component information such as a material identification number, material type, material size, material weight, and the like. The component database 315 may store the component information and associate the component information with a unique identifier for each component of the project. The design options database 320 allows the user to access various design options, which may be selected by the user to conform to particular rules submitted by the user. Information from each database is provided to an analysis module 330 to analyze and utilize the information to create a viable plan for the project.

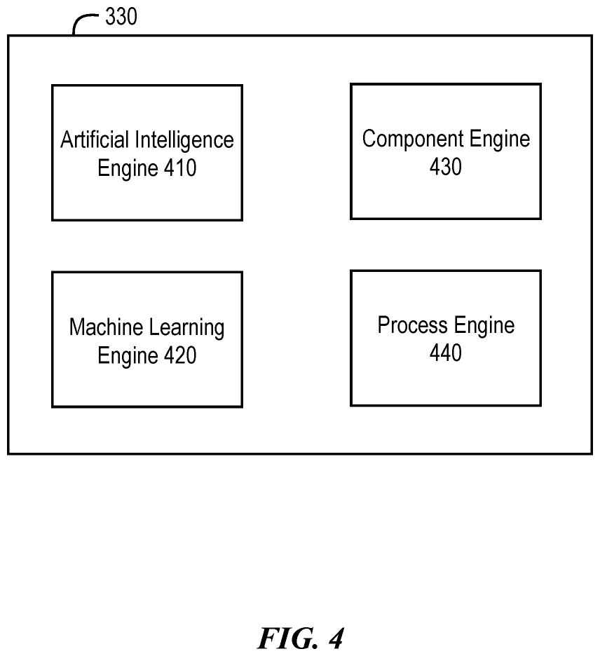

FIG. 4 illustrates a block diagram of the analysis engine 330 comprising an artificial intelligence engine 410 a machine learning engine 420, a component engine 430, and a process engine 440. User preferences, rules, and other information provided by the user may be transmitted to the artificial intelligence engine 410 and machine learning engine 420 to analyze the information and apply the information to future projects. In such, the artificial intelligence engine 410 and machine learning engine 420 may anticipate user interactions with the system, including rules for a particular component and component configuration based on previous actions performed by the user. The component engine 430 may analyze component options (e.g., shortening or lengthening a component, reducing the weight of a component, and the like) to suggest a suitable component based on a rule input by the user. The process engine 440 may analyze the construction process and subprocesses to determine a solution to a rule input by the user. The process engine 440 may utilize known practices for a project or process and implement the best practices to complete the project.

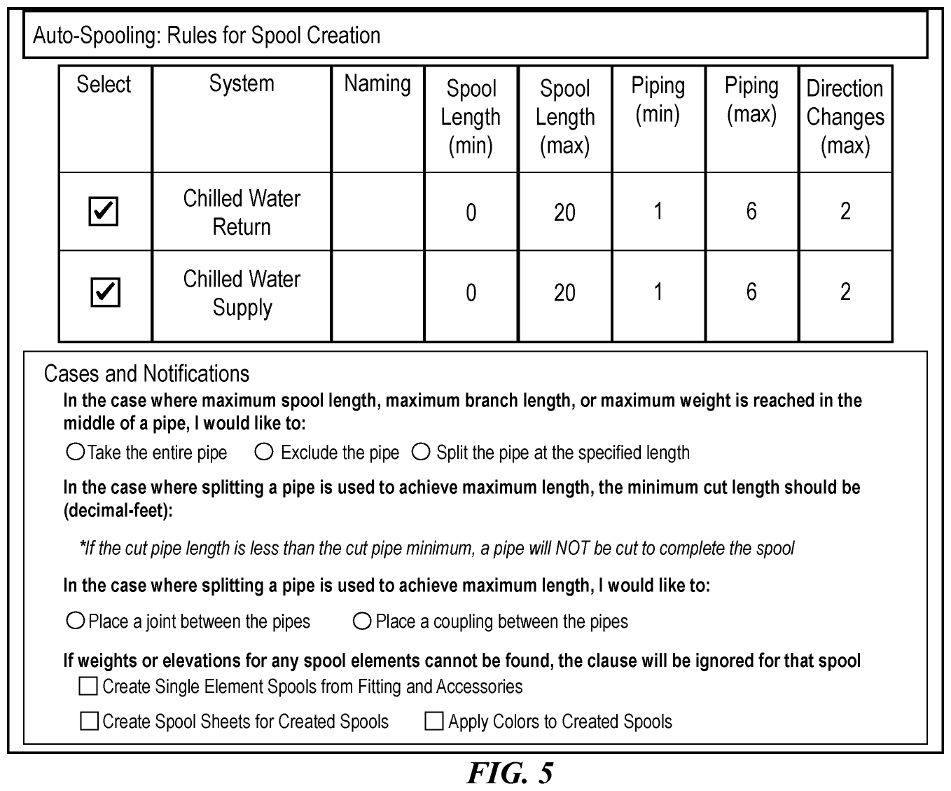

FIG. 5 illustrates a screenshot of the user interface comprising a plurality of inputs to permit the user to input rules. For example, inputs may include the system to which the rule will be applied, naming convention, minimum spool length, maximum spool length, minimum piping diameter, maximum piping diameter, direction changes, and the like. One skilled in the arts will readily understand that while the illustrated example relates to conduit systems, the embodiments may also apply to other aspects associated with the construction process including, but not limited to, plumbing, electrical, windows, formwork, framing, and the like. The user interface provides a cases and notifications interface where the user is asked to select various solutions to a rule if the rule is broken by the current design and component thereof. The system will then apply the rules and output a design conforming to the rules input by the user.

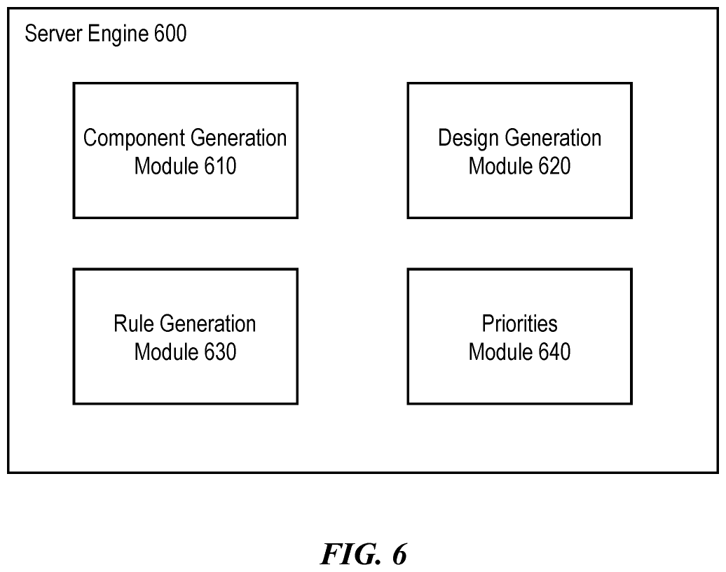

FIG. 6 illustrates a block diagram of the server engine 600 and modules related to the rule-based design system, including a component generation module 610, a design generation module 620, a rule generation module 630, and a priorities module 640. The component generation module 610 receives identifications and information related to the various components and permits the user to alter component features based on component parameters to generate a suitable component or set of components. The design generation module 620 generates a design from a plurality of components and other building elements to provide a complete design for a project. The rule generation module 630 permits the user to create and implement a plurality of rules which may be applied to the design. The priorities module 640 determines a priority level for each component, each design, and/or each rule.

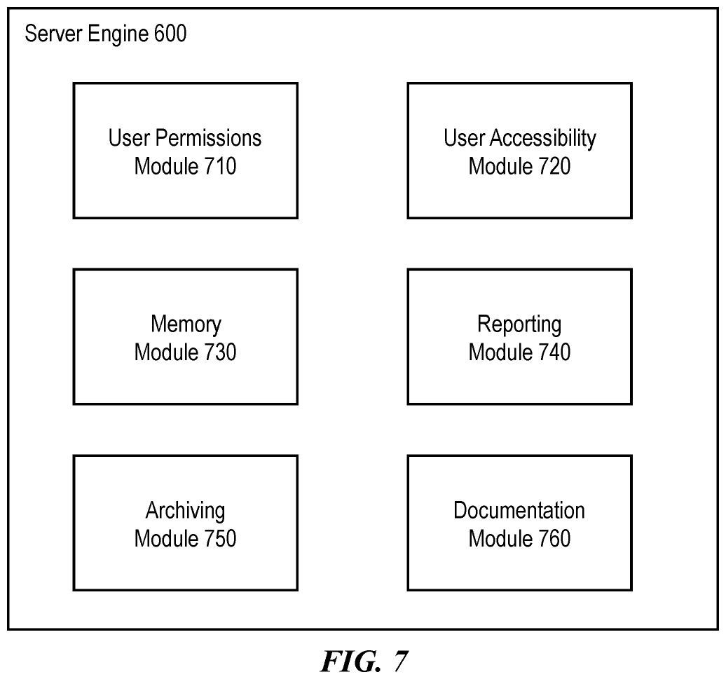

FIG. 7 illustrates a block diagram of the server engine 600 and modules associated with the rule-based design system, which allow for user permissions, functionalities of the system, and transmission of information through the system. A user permissions module 710 permits user permissions to be established, often via an administrative user. In such, groups of users or individual users may be granted access to various features of the system. A user accessibility module 720 provides user permissions to various third-parties of the system. A memory module 730 may store user accessibility information, user preferences information, user permissions information, and other information associated with the users of the system. A reporting module 740 allows for users to report issues with the system, which may be transmitted to an administrative user or systems programmer for correction of the reported issue. An archiving module 750 allows the user to archive projects that are in progress while retaining the ability to interact with other projects on the user interface. A documentation module 760 provides a means for automatically generating multiple documents for a project, component, user, label, continuity log, or other aspects of the system.

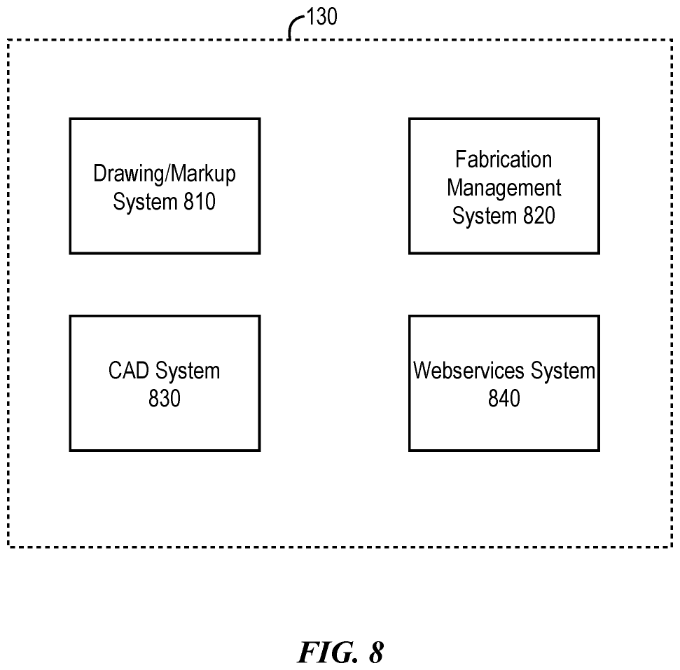

FIG. 8 illustrates a block diagram of the integrated third-party systems including a drawing/markup system 810 which may be used by the user to generate a markup of a design using their computing device. The markup may be transmitted to other users of the system or stored in a database for future use. The fabrication management system 820 permits the user to manage various aspects of the component fabrication process, which may integrate rules provided by the user. The user may utilize one or more computer-aided design (CAD) systems 830 to generate a design for various components of the construction project. The CAD systems 830 may provide the design to the rule-based design system for alterations based on user rules and user preferences. Various webservices systems 840 may be used, such as AutoDesk Forge and the like.

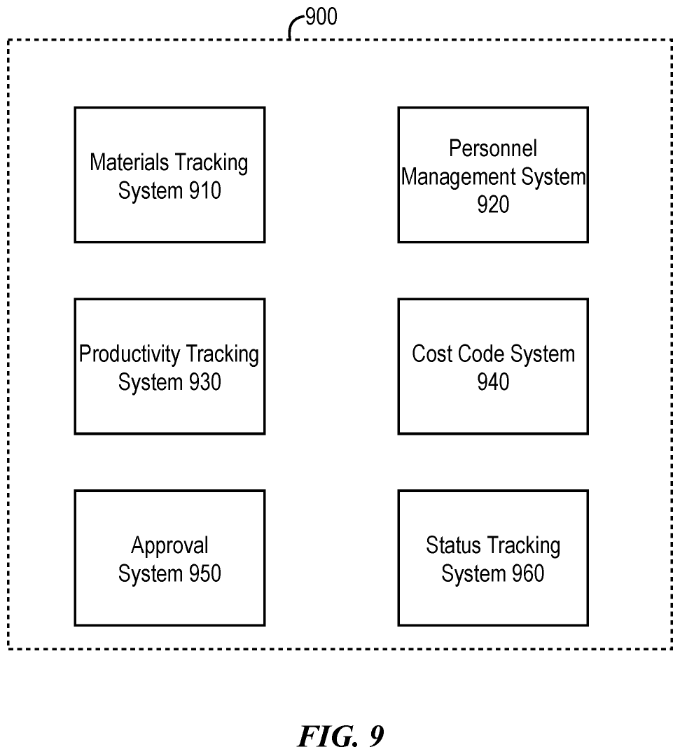

FIG. 9 illustrates a block diagram of the fabrication management engine 900 comprising a materials tracking system 910, a personnel management system 920, a productivity tracking system 930, cost code system 940, approval system 950, and a status tracking system 960. The materials tracking system may track the delivery, transmission, and processing of materials associated with various components of the system. The personnel management system 920 manages personnel processes and resources related to various fabrication processes. The productivity tracking system 930 may permit the user to manage productivity for personnel and the materials they are fabricating. The cost code system 940 provides a means for inputting information from accounting software and the automated tracking of labor. The approval system 950 allows for users to transmit information for approval, such as transmitted amended design plans generated by the rule-based design system. The status tracking system 960 provides users a means for tracking the status of a design stored within the system.

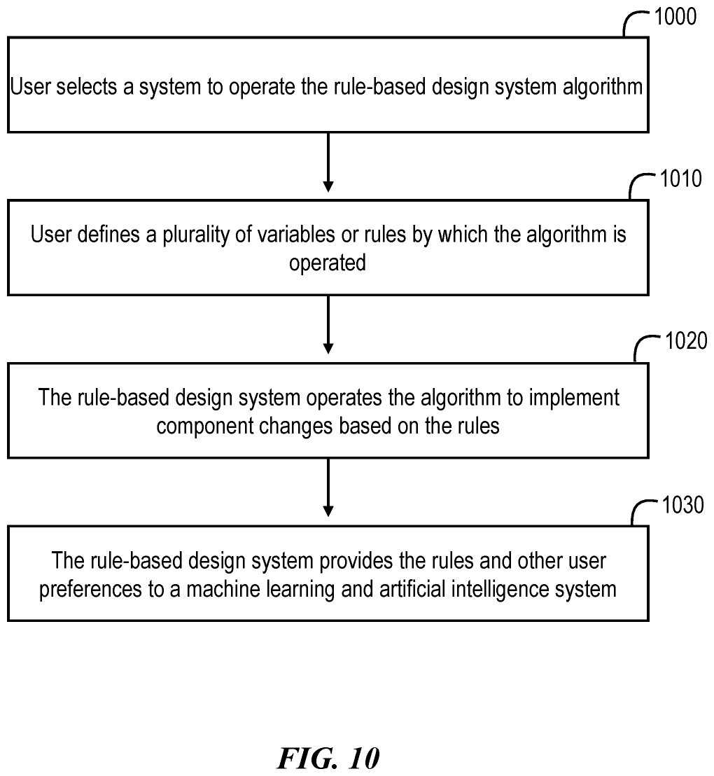

FIG. 10 illustrates a flowchart for a method of using the rule-based design system. In step 1000, the user selects a system to operate the rule-based design system algorithm. In step 1010, the user defines a plurality of variables or rules by which the algorithm is operated, and in step 1020, the system operates the algorithm to implement component changes based on the rules. In step 1030, the rule-based design system provides the rules and other user preferences to a machine learning and artificial intelligence system.

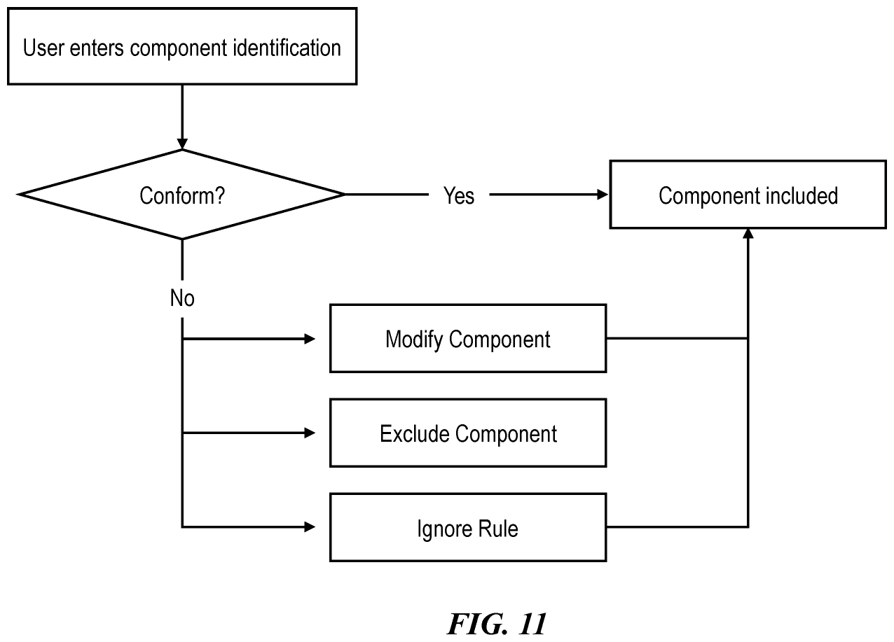

FIG. 11 illustrates a flowchart of the rules and modifications process wherein the user enters component identification information to the system. The system then determines if the component specifications associated with the component identification conform to rules provided by the user. If the component conforms to rules provided by the user, the component is included. If the component does not confirm to rules provided by the user, the system provides the option to, or automatically determines whether to modify the component to conform to the rules, exclude the component, or ignore the rule and provide the component.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A rule-based design system, comprising:
a design database to store a plurality of design information comprised of a plurality of components;
a rules database to store a plurality of rules input by a user, the rules associated to one or more of the plurality of components; and
a rules management system to apply the plurality of rules to at least one of the plurality of components and modifies the at least one of the plurality of components based on the plurality of rules.

2. The system of claim 1, wherein the plurality of rules are transmitted to an analysis engine to analyze the rules and apply the rules.

3. The system of claim 2, wherein the analysis system comprises an artificial intelligence engine to anticipate the plurality of rules provided by the user.

4. The system of claim 3, further comprising a user interface to provide a means for inputting the plurality of rules.

5. The system of claim 4, wherein the user interface comprises a cases and notifications interface to allow the user to select a solution to a breach of at least one of the plurality of rules.

6. The system of claim 5, further comprising a rule generation module in operable communication with the user interface to permit the generation of the plurality of rules.

7. The system of claim 6, further comprising a component generation module to generate a component conforming to the plurality of rules.

8. The system of claim 7, further comprising a design generation module to generate a design comprising the conforming component generated by the component generation module.

9. The system of claim 8, wherein a user permissions module provides a means for submitting user permissions to access the rule-based design system.

10. A rule-based design system, comprising:
a design database to store a plurality of design information comprised of a plurality of components stored in a components database;
a rules database to store a plurality of rules input by a user, the rules associated to one or more of the plurality of components to permit the modification of the plurality of components;
a rules management system to apply the plurality of rules to at least one of the plurality of components and modifies the at least one of the plurality of components based on the plurality of rules; and
a CAD system to permit the user to generate a design and transmit the design to the rule-based design system.

11. The system of claim 10, wherein the plurality of rules are transmitted to an analysis engine to analyze the rules and apply the rules.

12. The system of claim 11, wherein the analysis system comprises an artificial intelligence engine to anticipate the plurality of rules provided by the user.

13. The system of claim 12, further comprising a user interface to provide a means for inputting the plurality of rules.

14. The system of claim 13, wherein the user interface comprises a cases and notifications interface to allow the user to select a solution to a breach of at least one of the plurality of rules.

15. The system of claim 14, further comprising a rule generation module in operable communication with the user interface to permit the generation of the plurality of rules.

16. The system of claim 15, further comprising a component generation module to generate a component conforming to the plurality of rules.

17. The system of claim 16, further comprising a design generation module to generate a design comprising the conforming component generated by the component generation module.

18. The system of claim 17, wherein a user permissions module provides a means for submitting user permissions to access the rule-based design system.

19. The system of claim 18, wherein the analysis engine further comprises a machine learning engine to receive the plurality of rules apply the plurality of rules to the design.

20. A rule-based design system, comprising:
a design database to store a plurality of design information comprised of a plurality of components stored in a components database;
a rules database to store a plurality of rules input by a user, the rules associated to one or more of the plurality of components to permit the modification of the plurality of components;
a rules management system to apply the plurality of rules to at least one of the plurality of components and modifies the at least one of the plurality of components based on the plurality of rules;
a CAD system to permit the user to generate a design and transmit the design to the rule-based design system; and
an artificial intelligence engine to receive the plurality of rules and apply the plurality of rules to at least one of the one or more components without the users input.
